(19) United States
(12) Patent Application Publication
(10) Pub. No.: US 2020/0300426 A1
(43) Pub. Date: Sep. 24, 2020

(54) ARTWORK SUBSTRATE ENHANCING SYSTEM, METHOD, AND DEVICE

(71) Applicant: Miles Warren, Westminster, CO (US)

(72) Inventor: Miles Warren, Westminster, CO (US)

(21) Appl. No.: 16/826,245

(22) Filed: Mar. 22, 2020

Related U.S. Application Data
(60) Provisional application No. 62/822,343, filed on Mar. 22, 2019.

(51) Int. Cl. F21S 4/20; F21V 9/08; F21V 3/00; F21V 23/04; G09F 13/00

(52) U.S. Cl. CPC F21S 4/20; F21V 9/08; F21Y 2115/10; F21V 23/0435; G09F 13/005; F21V 3/00

(57) ABSTRACT

An artwork substrate enhancing system, method, and device are provided. An artwork substrate enhancing device may include a housing to which one or more light elements may be coupled. A processing unit and a power source may be in communication with the light elements, and the processing unit may control the electrical power communicated to the light elements from the power source to control the illumination generated by the light elements which may be directed on an artwork substrate to visually enhance the appearance of artwork substrates in a dynamic and changing manner. The processing unit may comprise one or more programs having one or more settings which may cause one or more different illumination patterns to be generated by the light elements. A control input may be positioned on the housing, and may be in communication with the processing unit.

### CROSS REFERENCE TO RELATED APPLICATIONS

This application claims priority to and the benefit of the filing date of U.S. Provisional Application No. 62/822,343, filed on Mar. 22, 2019, entitled “ARTWORK SUBSTRATE ENHANCING SYSTEM, METHOD, AND DEVICE”, which is hereby incorporated by reference in its entirety.

### FIELD OF THE INVENTION

This patent specification relates to the field of systems, methods and devices for enhancing artwork substrates. More specifically, this patent specification relates to a system, method, and device for visually enhancing the appearance of artwork substrates using alternating wavelengths of visible light.

### BACKGROUND

Art is integral to the human experience and people have been generating artwork in various forms since time immemorial. One such form is applying colored materials to substrates, such as paper products, canvas, and other objects, to form images and indicia. Examples include painting, and coloring with pencils, crayon, markers, pastels, and the like. Unfortunately, these art forms are limited in that the art is static or unchanging when viewed in everyday lighting. While most people are able to enjoy static art, a great proportion would also enjoy an un-static art viewing experience.

Therefore, a need exists for a novel system, method, and device for visually enhancing the appearance of artwork substrates. There is also a need for a novel system, method, and device for visually enhancing the appearance of artwork substrates in a dynamic and changing manner.

### BRIEF SUMMARY OF THE INVENTION

An artwork substrate enhancing system, method, and device are provided which may be configured to visually enhance the appearance of artwork substrates in a dynamic and changing manner.

According to an embodiment consistent with the principles of the invention, an artwork substrate enhancing device may include a housing to which one or more light elements may be coupled. A processing unit and a power source may be in communication with the light elements, and the processing unit may control the electrical power communicated to the light elements from the power source to control the illumination generated by the light elements. The processing unit may comprise one or more programs having one or more settings, optionally contained in one or more arrays, which may cause one or more different illumination patterns to be generated by the light elements. A control input may be positioned on the housing, and may be in communication with the processing unit. The control input may be manipulated by a user to allow the user to select which setting of a program may be active at a given time.

According to another embodiment consistent with the principles of the invention, an artwork substrate enhancing system may include one or more artwork substrate enhancing devices which may be configured to generate various colors and intensities of illumination which may be directed onto one or more artwork substrates. Preferably, each device may generate various and dynamic colors and intensities of illumination which may alter the wavelengths or colors of light which may be reflected off of one or more artwork substrates thereby altering the perception of the artwork substrates by one or more users.

In further embodiments, an artwork substrate enhancing system may include an artwork substrate enhancing device having one or more light elements and a processing unit. The processing unit may be operable to cause one illumination pattern, and more preferably at least two different illumination patterns, to be generated by the one or more light elements, and the artwork substrate enhancing device may be configured to direct the illumination pattern(s) onto an artwork substrate.

In still further embodiments, an artwork substrate enhancing system may include an artwork substrate enhancing device having one or more light elements, a radio, and a processing unit. The processing unit may include a modulation engine that is operable to allow a user to select a number of illumination settings, each illumination setting including one illumination pattern, and more preferably at least two different illumination patterns, to be generated by the light element, and the illumination pattern(s) generated by the light element may be directed onto an artwork substrate. A client device may be in communication with the radio, and the client device may be operable by the user to provide input to the program to select the illumination settings.

According to yet another embodiment consistent with the principles of the invention, an artwork substrate enhancing method may include the steps of: generating illumination via one or more light elements according to an initial setting; performing a hardware interrupt to check for user input; determining if a user has interacted with a control input; determining if the user has interacted with the control input in a first manner of input; determining if the current setting is the last setting in the array; switching to the next setting in the array and controlling the illumination of the light elements accordingly.

### BRIEF DESCRIPTION OF THE DRAWINGS

Some embodiments of the present invention are illustrated as an example and are not limited by the figures of the accompanying drawings, in which like references may indicate similar elements and in which:

FIG. 1—FIG. 1 a block diagram illustrating some components of an example of an artwork substrate enhancing device according to various embodiments described herein.

FIG. 2—FIG. 2 illustrates depicts a top perspective view of an example of an artwork substrate enhancing device configured as a hand held device according to various embodiments described herein.

FIG. 3—FIG. 3 shows a bottom perspective view of an example of an artwork substrate enhancing device configured as a hand held device according to various embodiments described herein.

FIG. 4—FIG. 4 depicts a perspective view of another example of an artwork substrate enhancing device configured as a picture frame box device in a closed position according to various embodiments described herein.

FIG. 5—FIG. 5 illustrates a perspective view of the example artwork substrate enhancing device of FIG. 4 in an open position according to various embodiments described herein.

FIG. 6—FIG. 6 shows a sectional, through line 6-6 shown in FIG. 4, elevation view of an example of an artwork substrate enhancing device according to various embodiments described herein.

FIG. 7—FIG. 7 depicts a perspective view of another example of an artwork substrate enhancing device configured as a light bulb device according to various embodiments described herein.

FIG. 8—FIG. 8 illustrates a sectional, through line 8—shown in FIG. 7, elevation view of an example of an artwork substrate enhancing device according to various embodiments described herein.

FIG. 9—FIG. 9 shows a perspective view of another example of an artwork substrate enhancing device configured as a light strip device according to various embodiments described herein.

FIG. 10—FIG. 10 depicts an illustrative example of some of the components and computer implemented methods which may be found in an artwork substrate enhancing system according to various embodiments described herein.

FIG. 11—FIG. 11 illustrates a block diagram illustrating some applications of an artwork substrate enhancing system which may function as software rules engines according to various embodiments described herein.

FIG. 12—FIG. 12 shows a block diagram of an example of an artwork substrate enhancing method according to various embodiments described herein.

FIG. 13—FIG. 13 depicts a block diagram showing an example of a server which may be used by the system as described in various embodiments herein.

FIG. 14—FIG. 14 illustrates a block diagram illustrating an example of a client device which may be used by the system as described in various embodiments herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

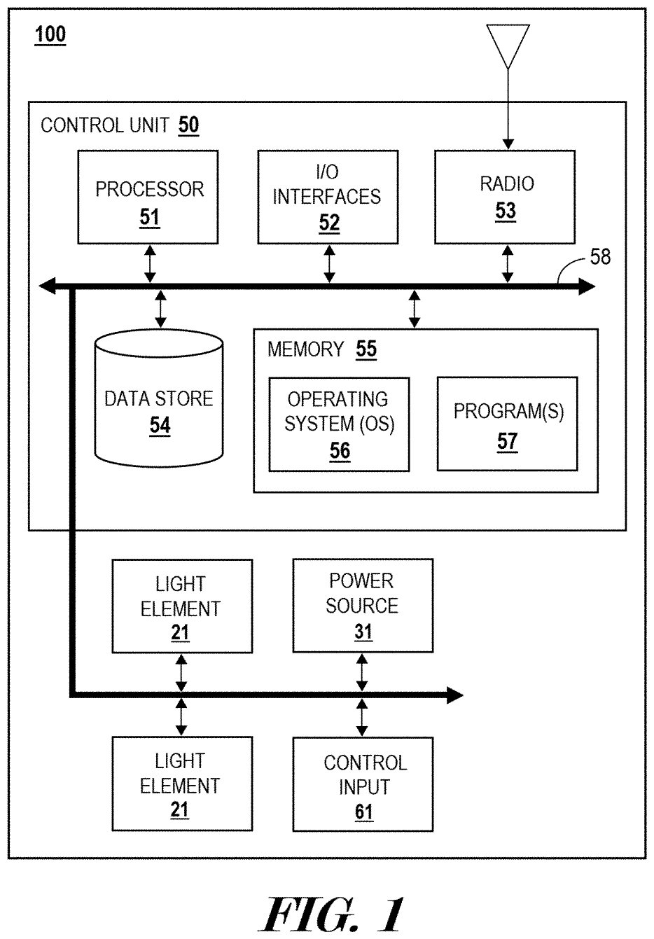

For purposes of description herein, the terms “upper”, “lower”, “left”, “right”, “rear”, “front”, “side”, “vertical”, “horizontal”, and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts of the invention. Hence, specific dimensions and other physical characteristics relating to the embodiments disclosed herein are not to be considered as limiting, unless expressly stated otherwise.

Although the terms “first”, “second”, etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 10% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

### Definitions

As used herein, the terms “computer” and “computing device” refer to a machine, apparatus, or device that is capable of accepting and performing logic operations from software code. The term “application”, “software”, “software code”, “source code”, “script”, or “computer software” refers to any set of instructions operable to cause a computer to perform an operation. Software code may be operated on by a “rules engine” or processor. Thus, the methods and systems of the present invention may be performed by a computer or computing device having a processor based on instructions received by computer applications and software.

The term “electronic device” as used herein is a type of computer comprising circuitry and configured to generally perform functions such as recording audio, photos, and videos; displaying or reproducing audio, photos, and videos; storing, retrieving, or manipulation of electronic data; providing electrical communications and network connectivity; or any other similar function. Non-limiting examples of electronic devices include: personal computers (PCs), workstations, servers, laptops, tablet PCs including the iPad, cell phones including iOS phones made by Apple Inc., Android OS phones, Microsoft OS phones, Blackberry phones, digital music players, or any electronic device capable of running computer software and displaying information to a user, memory cards, other memory storage devices, digital cameras, external battery packs, external charging devices, and the like. Certain types of electronic devices which are portable and easily carried by a person from one location to another may sometimes be referred to as a “portable electronic device” or “portable device”. Some non-limiting examples of portable devices include: cell phones, smartphones, tablet computers, laptop computers, wearable computers such as Apple Watch, other smartwatches, Fitbit, other wearable fitness trackers, Google Glasses, and the like.

The term “client device” as used herein is a type of computer or computing device comprising circuitry and configured to generally perform functions such as recording audio, photos, and videos; displaying or reproducing audio, photos, and videos; storing, retrieving, or manipulation of electronic data; providing electrical communications and network connectivity; or any other similar function. Non-limiting examples of client devices include: personal computers (PCs), workstations, servers, laptops, tablet PCs including the iPad, cell phones including iOS phones made by Apple Inc., Android OS phones, Microsoft OS phones, Blackberry phones, Apple iPads, Anota digital pens, digital music players, or any electronic device capable of running computer software and displaying information to a user, memory cards, other memory storage devices, digital cameras, external battery packs, external charging devices, and the like. Certain types of electronic devices which are portable and easily carried by a person from one location to another may sometimes be referred to as a “portable electronic device” or “portable device”. Some non-limiting examples of portable devices include: cell phones, smartphones, tablet computers, laptop computers, tablets, digital pens, wearable computers such as Apple Watch, other smartwatches, Fitbit, other wearable fitness trackers, Google Glasses, and the like.

As used herein the term “data network” or “network” shall mean an infrastructure capable of connecting two or more computers such as client devices either using wires or wirelessly allowing them to transmit and receive data. Non-limiting examples of data networks may include the internet or wireless networks or (i.e. a “wireless network”) which may include Wifi and cellular networks. For example, a network may include a local area network (LAN), a wide area network (WAN) (e.g., the Internet), a mobile relay network, a metropolitan area network (MAN), an ad hoc network, a telephone network (e.g., a Public Switched Telephone Network (PSTN)), a cellular network, a Zigbee network, or a voice-over-IP (VoIP) network.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

A new computer-implemented artwork substrate enhancing system, methods, and device are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

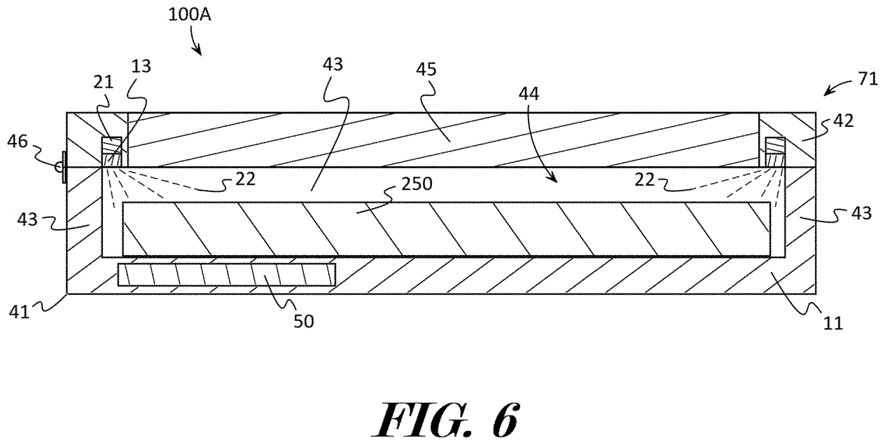

The present invention will now be described by example and through referencing the appended figures representing preferred and alternative embodiments. FIGS. 1-9 illustrate examples of an artwork substrate enhancing device (“the device”) 100 according to various embodiments. In some embodiments, the device 100 may comprise a housing 11 to which one or more light elements 21 may be coupled. A processing unit 50 and a power source 31 may be in communication with the light elements 21, and the processing unit 50 may control the electrical power communicated to the light elements 21 from the power source 31 to control the illumination generated by the light elements 21. The processing unit 50 may comprise one or more programs 57, such as a modulation engine 59, having one or more settings, optionally contained in one or more arrays, which may cause one or more different illumination patterns to be generated by the light elements 21. A control input 61 may be positioned on the housing 11, and may be in communication with the processing unit 50. The control input 61 may be manipulated by a user 201 to allow the user 201 to select which setting of a modulation engine 59 may be active at a given time.

FIG. 1 shows a block diagram of an example of a device 100 according to various embodiments described herein. In some embodiments and in the present example, the device 100 can be a digital device that, in terms of hardware architecture, comprises a processing unit 50 which generally includes a processor 51, input/output (I/O) interfaces 52, an optional radio 53, a data store 54, and memory 55. Optionally, the processing unit 50 may be configured as a microcontroller. It should be appreciated by those of ordinary skill in the art that FIG. 1 depicts the processing unit 50 in an oversimplified manner, and a practical embodiment may include additional components or elements and suitably configured processing logic to support known or conventional operating features that are not described in detail herein.

The components of a processing unit 50 and elements (21, 31, 61) may be communicatively coupled via a local interface 58. The local interface 58 can be, for example but not limited to, one or more buses or other wired or wireless connections, integrated circuits, etc., as is known in the art. The local interface 58 can have additional elements, which are omitted for simplicity, such as controllers, buffers (caches), drivers, repeaters, and receivers, among many others, to enable communications. Further, the local interface 58 may include address, control, and/or data connections to enable appropriate communications among the aforementioned components.

The processor 51 is a hardware device for executing software instructions. The processor 51 can be any custom made or commercially available processor, a central processing unit (CPU), an auxiliary processor among several processors associated with the processing unit 50, a semiconductor-based microprocessor (in the form of a microchip or chip set), or generally any device for executing software instructions. When the processing unit 50 is in operation, the processor 51 is configured to execute software stored within the memory 55, to communicate data to and from the memory 55, and to generally control operations of the device 100 pursuant to the software instructions. In an exemplary embodiment, the processor 51 may include a mobile optimized processor such as optimized for power consumption and mobile applications.

The I/O interfaces 52 can be used to input and/or output information and power. The I/O interfaces 52 can also include, for example, a serial port, a parallel port, a small computer system interface (SCSI), an infrared (IR) interface, a radio frequency (RF) interface, a universal serial bus (USB) interface, and the like.

Optionally, the device 100 may comprise a radio 53 which may enable wireless communication to an external access device or network. In preferred embodiments, a radio 53 may operate via WiFi and/or Bluetooth communication standards to enable a wireless data connection 106 between the device 100 and a radio 406 of a client device 400. In further embodiments, a radio 53 may operate on a cellular band and may communicate with or receive a Subscriber Identity Module (SIM) card or other wireless network identifier. Any number of suitable wireless data communication protocols, techniques, or methodologies can be supported by the radio 53, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Near-Field Communication (NFC); Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication.

The data store 54 may be used to store data. The data store 54 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 54 may incorporate electronic, magnetic, optical, and/or other types of storage media.

The memory 55 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 55 may incorporate electronic, magnetic, optical, and/or other types of storage media. Note that the memory 55 may have a distributed architecture, where various components are situated remotely from one another, but can be accessed by the processor 51. The software in memory 55 can include one or more software programs, each of which includes an ordered listing of executable instructions for implementing logical functions.

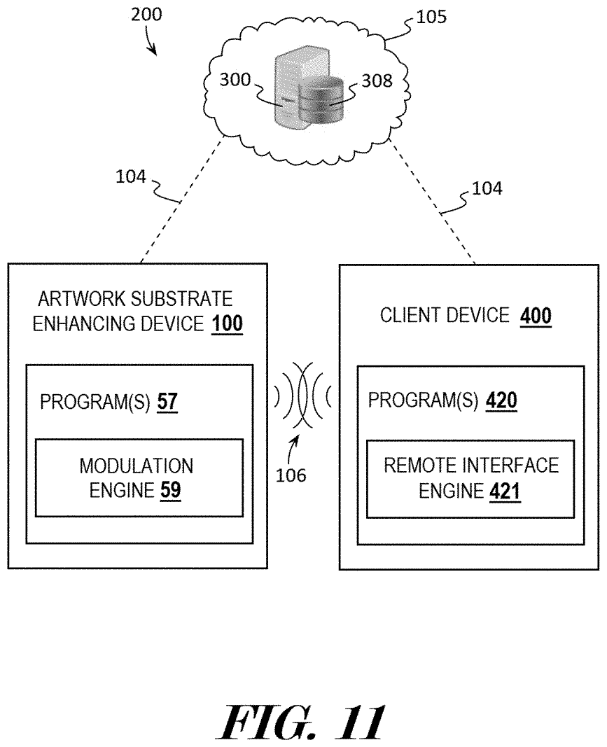

In the example of FIG. 1, the software in the memory system 55 includes a suitable operating system (O/S) 56 and programs 57. The operating system 56 essentially controls the execution of input/output interface 52 functions, and provides scheduling, input-output control, file and data management, memory management, and communication control and related services. The operating system 56 may be, for example, LINUX (or another UNIX variant), Android (available from Google), Symbian OS, Microsoft Windows CE, Microsoft Windows 7 Mobile, iOS (available from Apple, Inc.), webOS (available from Hewlett Packard), Blackberry OS (Available from Research in Motion), Raspbian (available from the Raspberry Pi Foundation) and the like. The programs 57 may include a modulation engine 59 (FIG. 11) and various applications, add-ons, etc. configured to provide end user functionality with the device 100. For example, exemplary programs 57 may include, but not limited to, environmental variable analytics and modulation of input/output interface 52 functions. In a typical example, the end user typically uses one or more of the programs 57 to control functions of the device 100 and to control the illumination generated by the light elements 21.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequences of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

The processing unit 50 may also include a main memory, such as a random access memory (RAM) or other dynamic storage device (e.g., dynamic RAM (DRAM), static RAM (SRAM), and synchronous DRAM (SDRAM)), coupled to the bus for storing information and instructions to be executed by the processor 51. In addition, the main memory may be used for storing temporary variables or other intermediate information during the execution of instructions by the processor 51. The processing unit 50 may further include a read only memory (ROM) or other static storage device (e.g., programmable ROM (PROM), erasable PROM (EPROM), and electrically erasable PROM (EEPROM)) coupled to the bus for storing static information and instructions for the processor 51.

The device 100 may comprise one or more light elements 21 which may be configured to illuminate with various colors and intensities of light allowing a plurality of color patterns and intensity patterns to be generated by the device 100. In some embodiments, a light element 21 may comprise one or more light emitting diodes (LEDs) which may be configured to provide light of various wavelengths and intensities. In other embodiments, a light element 21 may comprise an organic light-emitting diode (OLED), incandescent light bulb, fluorescent light, bulb halogen light bulb, high-intensity discharge light bulb, laser light emitter, electroluminescent light source, neon light source, or any other type of suitable light source.

The device 100 may comprise one or more control inputs 61 which may be positioned anywhere on the housing 11 and/or on a light diffusing cover 13. A control input 61 may be manipulated by a user 201 to allow the user 201 to select which setting and/or array may be active or performed by a modulation engine 59 at a given time. In some embodiments, a control input 61 may include one or more depressible button type switches, turnable control knobs, a key pad, slide type switches, dip switches, rocker type switches, rotary dial switches, numeric input switches or any other suitable input which a user may interact with to provide input.

A power source 31 may supply electrical power to the device 100. In some embodiments, the device 100 may comprise a power source 31 which may provide electrical power to any component that may require electrical power. A power source 31 may comprise a battery, such as a lithium ion battery, nickel cadmium battery, alkaline battery, or any other suitable type of battery, a fuel cell, a capacitor, a super capacitor, or any other type of energy storing and/or electricity releasing device. In further embodiments, a power source 31 may comprise a power cord, kinetic or piezo electric battery charging device, a solar cell or photovoltaic cell, and/or inductive charging or wireless power receiver. In further embodiments, a power source 31 may comprise a power charging and distribution module which may be configured to control the recharging of the power source 31, discharging of the power source 31, and/or distribution of power to one or more components of the device 100 that may require electrical power. In alternative embodiments, the device 100 may not comprise a power source 31, but may be in communication with a power source 31 via a wired connection, such as an electrical cord.

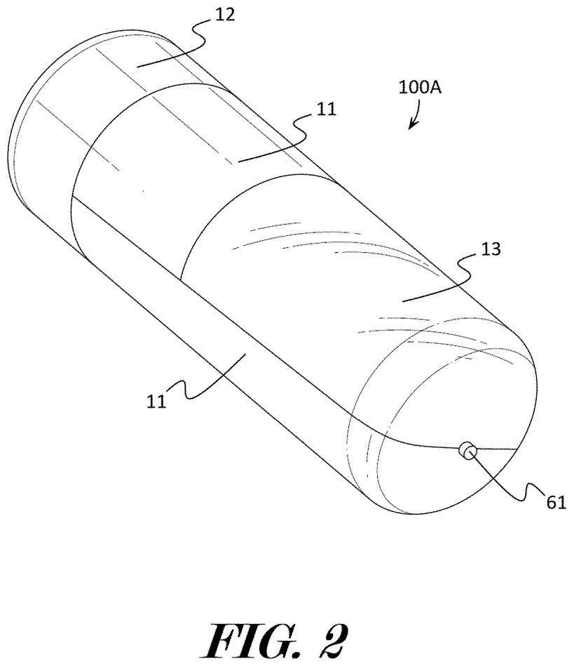

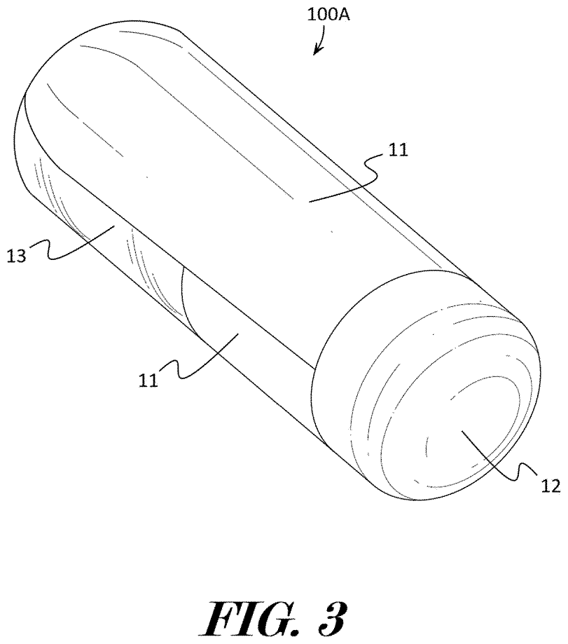

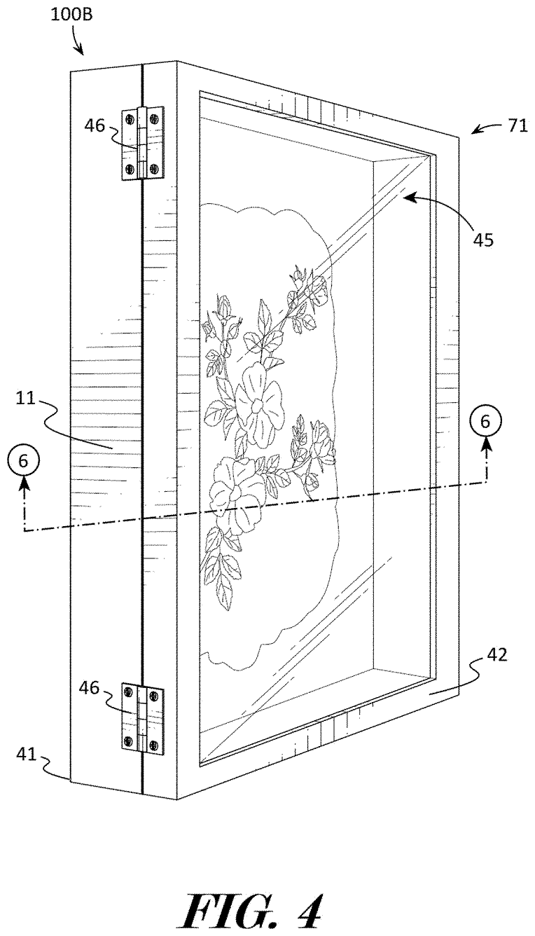

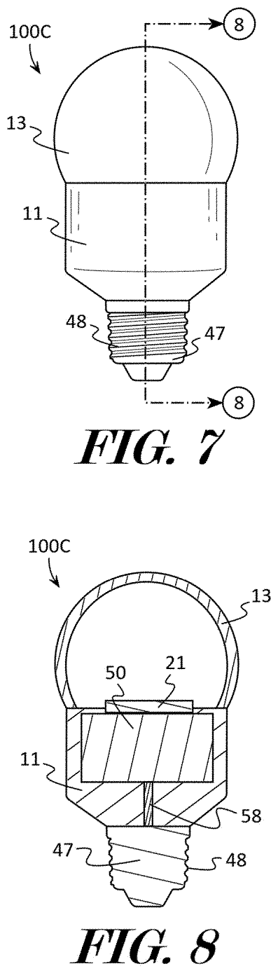

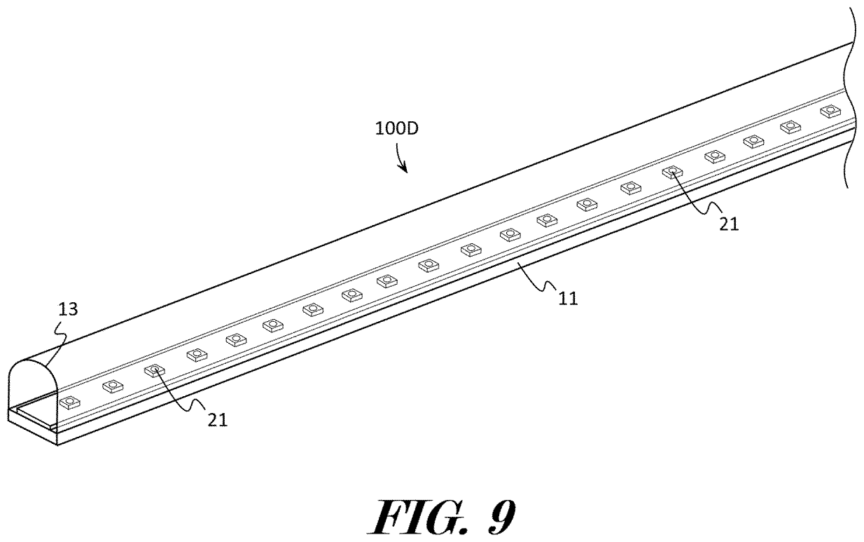

The device 100 may comprise a housing 11 which may be configured in any shape and size, such as rectangular prism shaped, generally triangular prism shaped, or with any other shape including combinations of shapes, to give the device 100 any style of form factor. For example, a housing 11 may be configured as being generally capsule shaped as shown in FIGS. 2 and 3. As another example, a housing 11 may be configured generally as a picture frame box as shown in FIGS. 4-6. As a further example, a housing 11 may be configured generally as a light bulb as shown in FIGS. 7 and 8. As yet another example, a housing 11 may be configured generally as a light strip as shown in FIG. 9. It should be understood that a housing 11 may be configured as a spot light, ceiling track light, chandelier, or any other style of light producing fixture.

In some embodiments, and as shown in FIGS. 2 and 3, the device 100 may be configured as a hand held device 100A having a housing 11 that may be configured as being generally capsule shaped with a rounded or smooth surface suitable for being held and positioned by people, including children. Optionally, a battery compartment cover 12 may comprise a flat surface upon which the device 100 may be rested.

A housing 11 may be made from or may comprise a substantially rigid material, suitable for supporting the housing 11 and other elements of the device 100. A substantially rigid material may comprise steel alloys, aluminum, aluminum alloys, copper alloys, other types of metal or metal alloys, ceramics such as alumina, porcelain, and boron carbide, earthenware, natural stone, synthetic stone, various types of hard plastics, such as polyethylene (PE), Ultra-high-molecular-weight polyethylene (UHMWPE, UHMW), polypropylene (PP) and polyvinyl chloride (PVC), polycarbonate, nylon, Poly(methyl methacrylate) (PMMA) also known as acrylic, melamine, hard rubbers, fiberglass, carbon fiber, resins, such as epoxy resin, wood, other plant based materials, or any other material including combinations of materials that are substantially rigid.

In some embodiments, the device 100 may comprise a battery compartment cover 12 which may be used to secure a power source 31, such as a replaceable battery 14, in a battery compartment which may provide electrical power to an element that may require electrical power and to any other electronic device or electronics that may optionally be in electrical communication with a processing unit 50 (FIG. 1). Access to the battery compartment may be governed by the battery compartment cover 12 which may be configured as a lid, door, etc., and which may from a removable covering over the battery compartment. In preferred embodiments, a battery compartment cover 12 may be removably coupled to the housing 11, via threading, a fastener, such as a threaded fastener, clasp fastener, push or slide to lock fastener, or any other suitable removable coupling method.

In some embodiments, the device 100 may comprise a light diffusing cover 13 which may be coupled to the housing 11. Generally, a light diffusing cover 13 may be positioned to cover or conceal all or portions of the light element(s) 21 which may preferably be positioned within the device 100, and each light diffusing cover 13 may be configured to allow light from the light element(s) 21 to pass through it. A light diffusing cover 13 may be made from or comprise a transparent or translucent material, such as polycarbonate, acrylic or polyacrylate made from Methyl Methacrylate (MMA), Poly Methyl Methacrylate, or a combination of both, polystyrene, glass, or any other substantially transparent or translucent material. In further embodiments, a light diffusing cover 13 may be configured to direct, diffuse, or otherwise manipulate the direction and/or color of light emitted by a light element 21. For example, a light diffusing cover 62 may comprise one or more, such as a plurality, of ridges such as may be found on a Fresnel lens.

In some embodiments, and as shown in FIGS. 4-6, the device 100 be configured as a picture frame box 100A by comprising a frame 41. Generally, a frame 41 may form a picture frame box having a lid 42 which may be movably and/or removably coupled to the housing 11 and which may form a cavity 44 for removably receiving an artwork substrate 250. Preferably, a frame 41 may comprise a rectangular prism shape and have a rectangular prism shaped cavity 44. Alternatively, a frame 41 and its cavity 44 may be configured in any other shape and size.

In some embodiments, a frame 41 may comprise one or more sidewalls 43, such as four sidewalls 43 for a rectangular prism shaped frame 41, which may be coupled to a housing 11 and a lid 42 which may be movably and/or removably coupled to the housing 11 by being coupled to one or more sidewalls 43 via one or more hinges 46. The sidewalls 43 may extend away from the housing 11, and the lid 42 may preferably contact one or more sidewalls 43 when in the closed position 71. In this manner the lid 42, the sidewalls 43, and the housing 11 may generally form a rectangular prism shaped box.

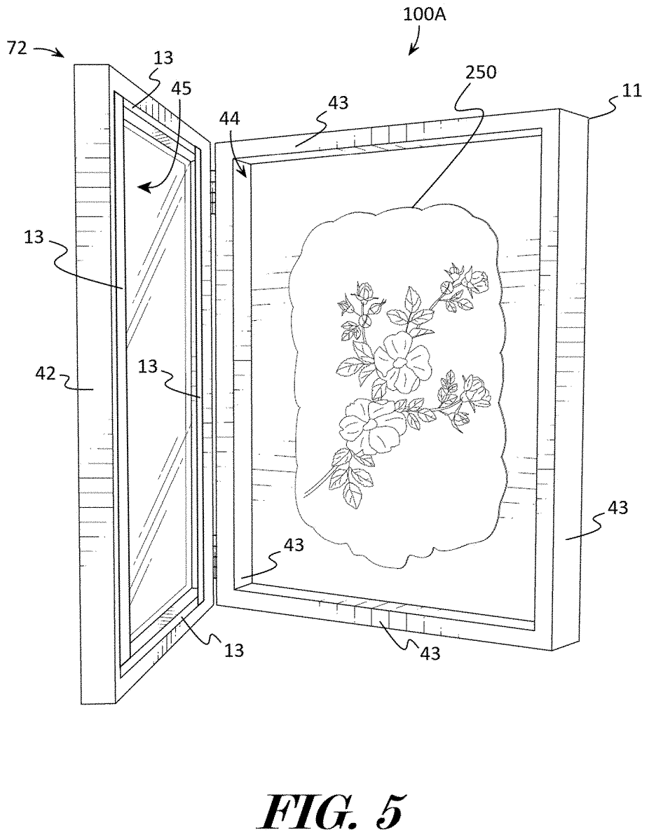

Preferably, the lid 42 may comprise a viewing portal 45, optionally formed of transparent glass, plastic, or other transparent or translucent material, which may allow a user 201 to see through the lid 42 to observe an artwork substrate 250 disposed in the cavity 44. A lid 42 may be moved between a closed position 71 (FIG. 4) and an open position 72 (FIG. 5) via hinges 46, a slide to open/shut connection method, or any other suitable movably connection method. Example hinges 46 include butt hinges, piano hinges, barrel hinges, butt/Mortise hinges, case hinges, although any type of hinge may be used.

One or more light elements 21 may be coupled to a lid 42 and/or housing 11 and may be configured to generate various colors and intensities of illumination into the cavity 44 which may alter the wavelengths or colors of light which may be reflected off of one or more artwork substrates 250 disposed in the cavity 44. Preferably, one or more of the light elements 21 may provide their illumination to the cavity 44 through a light diffusing cover 13.

In some embodiments, and as shown in FIGS. 7-8, the device 100 may be configured as a light bulb 100B. Generally, a device 100 configured as a light bulb may comprise a light diffusing cover 13 which may be generally bulbous in shape or otherwise shaped to resemble the transparent or translucent portions of a light bulb. Preferably, the device 100 may comprise a coupler 47 which may be configured to couple to the device 100 to various objects and surfaces. In some embodiments, a coupler 47 may comprise a hook, clamp, clip, etc., which may allow the device 100 to be hung from or otherwise removably attached to objects similar to a camping light bulb. In further embodiments, a coupler 47 may comprise a track lighting coupler which may enable the device 100 to function as a spot light or other type of track lighting fixture. In preferred embodiments, a coupler 47 may comprise socket threading 48 which may enable the device 100 to mate with a threaded light socket, such as which is used to removably coupled a threaded light bulb. The socket threading 48 may conduct electricity so that when the socket threading is mated to a powered, threaded light socket, the device 100 may receive electrical power from the light socket via the socket threading 48.

In some embodiments, and as shown in FIG. 9, the device 100 may be configured as a light strip 100C having a plurality of light elements 21 which may be arranged in a linear fashion on an elongated housing 11. A plurality of light elements 21 may comprise three, four, five, six, seven, and preferably eight, nine, ten or more light elements 21. A device 100 configured as a light strip 100C may also include an elongated light diffusing cover 13 which may cover, one or more, and more preferably all of the light elements 21 so that the light elements 21 are disposed between the light diffusing cover 13 and housing 11.

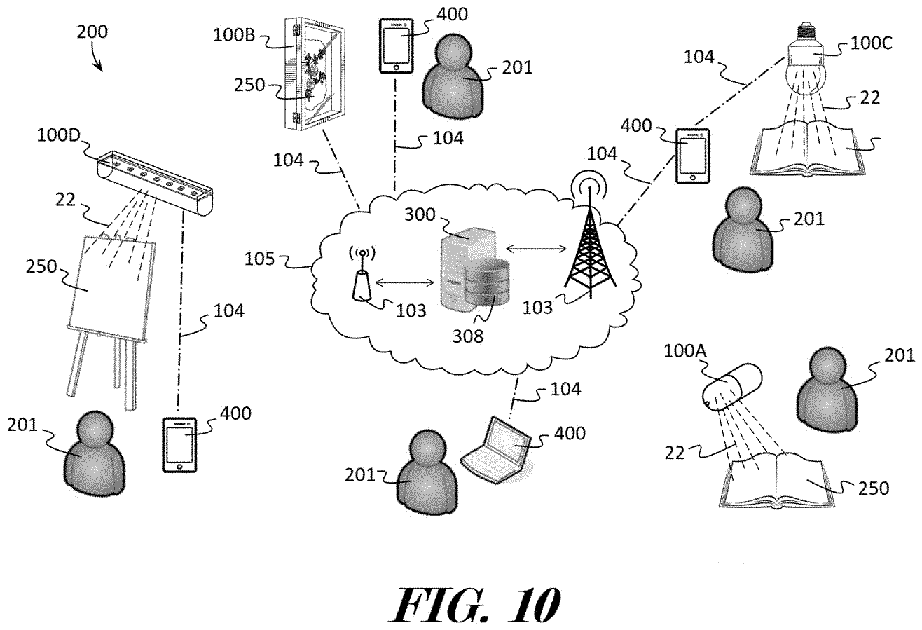

FIG. 10 illustrates an example of an artwork substrate enhancing system (“the system”) 200 according to various embodiments described herein. A system 200 may comprise one or more devices 100, such as hand held device(s) 100A, picture frame box device(s) 100B, light bulb device(s) 100C, and light strip device(s) 100D ,which may be configured to generate various colors and intensities of illumination which may be directed onto one or more artwork substrates 250 as an illumination pattern 22. Preferably, each device 100 may generate various colors and intensities of illumination patterns 22 which may alter the wavelengths or colors of light which may be reflected off of one or more artwork substrates 250 thereby altering the perception of the artwork substrates 250 by one or more users 201. Optionally, one or more devices 100 of the system 200 may be in communication with each other. In preferred embodiments, one or more devices 100 of the system 200 may be in communication with one or more client devices 400, such as a smartphone, tablet computer, laptop, etc., so that the illumination generated by the devices 100 may be coordinated or otherwise controlled by client device(s) 400. In further embodiments, communication between a device 100 and a client device 400 may be enabled via server(s) 300 and network connections 104. In this manner, the system 200 is configured to facilitate the transfer of data and information between one or more devices 100, access points 103, client devices 400, and servers 300 over a data network 105. Each client device 400 may send data to and receive data from the data network 105 through a network connection 104 with an access point 103.

An artwork substrate 250 may comprise any object of artwork or any object upon which artwork may be applied. In preferred embodiments, an artwork substrate 250 may comprise a coloring book, coloring sheet, or the like, to which color vehicles, such as colored pencils, crayons, markers, pastels, chalk, paint, etc., may be applied. In further embodiments, an artwork substrate 250 may comprise paintings, such as which may be created by applying paint or other color vehicles to canvas, walls, paper, etc. In still other embodiments, an artwork substrate 250 may comprise sculptures and other three-dimensional physical representations and creations optionally to which color vehicles may be applied. In yet further embodiments, an artwork substrate 250 may comprise any object or entity which may be observed by a user 201 using illumination generated by a device 100.

Referring now to FIG. 11 a block diagram showing some software rules engines and components which may be found in a system 200 and which may optionally be configured to run on one or more devices 100, servers 300 and/or client devices 400 according to various embodiments described herein are illustrated. In some embodiments, a device 100 may be in direct electronic communication with a client device 400 via a wired, and more preferably, a wireless data connection 106. In further embodiments, a device 100 and client device 400 may be in wired and/or wireless electronic communication through a network 105 via a server 300. The engines 59, 421, may be in electronic communication so that data may be readily exchanged between the engines 59, 421, and optionally one or more engines 59, 421, may read, write, or otherwise access data in one or more databases of one or more data stores 308.

In this and some embodiments, one or more devices 100 may be configured to run one or more software rules engines or programs such as a modulation engine 59 while a client device 400 may be configured to run one or more software rules engines or programs such as a remote interface engine 421. In other embodiments, a modulation engine 59 and/or remote interface engine 421 may be configured to run on one or more devices 100, client devices 400, and/or servers 300 with data transferred to and from a modulation engine 59 and/or remote interface engine 421 that may be in communication through a network 105. It should be understood that the functions attributed to the engines 59, 421, described herein are exemplary in nature, and that in alternative embodiments, any function attributed to any engine 59, 421, may be performed by one or more other engines 59, 421, or any other suitable processor logic.

In some embodiments, a modulation engine 59 may comprise or function as modulation logic stored in a memory 55, 310, 410, which may be executable by the processor 51, 302, 402, of a device 100, server 300, and/or client device 400. Generally, a modulation engine 59 may control the color, intensity or brightness, and the length of time(s) for the one or more colors and light intensity or brightness level(s) brightness of illumination that may be generated by the light elements 21. User 201 input may be provided to a modulation engine 59, via a control input 61 and/or via an I/O interface 404 and a remote interface engine 421 of a client device 400 that may be in communication with the modulation engine 59, and the modulation engine 59 may use that user input to control or change the illumination pattern(s) 22 of a device 100.

A modulation engine 59 may be is operable to allow a user 201 to select a number of illumination settings in which each illumination setting is used by the modulation engine to generate an illumination pattern 22 via the one or more light elements 21 of a device 100. In some embodiments, a device 100 may include a control input 61, and the control input 61 may be operable by a user 201 to select one or more illumination settings, such as which may be used to form an array. In further embodiments, a device 100 may include a radio 53, a client device 400 may be in communication with the radio 53, such as via a radio 406 of the client device 400, and the client device 400 may be operable by the user 201 to select one or more illumination settings, such as which may be used to form an array. Each array may comprise one or more illumination settings. Each illumination setting may comprise data that is used by the processor 51 (via a modulation engine 59) to cause one or more light elements 21 of a device 100 to generate an illumination pattern 22 via the illumination output by the one or more light elements 21. Each illumination pattern may include: one or more colors of light to be output by one or more light elements 21; one or more light intensity or brightness level(s) for each of the one or more colors of light to be output by one or more light elements 21; a length of time for each of the one or more colors of light to be output by one or more light elements 21; and/or a length of time for each light intensity or brightness level(s) for each of the one or more colors of light to be output by one or more light elements 21. For example, an illumination setting may comprise data which may be used by a modulation engine 59 to allow a processor 51 to operate one or more light elements 21 to generate an illumination pattern 22 that includes fading (moving from low brightness to high brightness and then back to low brightness) between the colors red, green, and blue, for time periods of 2 seconds for red, 3 seconds for green, and 2.5 seconds for blue. As another example, an illumination setting may comprise data which may be used by a modulation engine 59 to allow a processor 51 to operate one or more light elements 21 to generate an illumination pattern 22 that includes fading (moving from low brightness to high brightness and then back to low brightness) between the colors red, green, and blue, for time periods of 10 seconds for red (increasing in brightness from off to high then off), 9 seconds for green (decreasing in brightness from high to off then increasing to high), and 20 seconds for blue (repeatedly pulsing from low brightness to medium brightness).

In preferred embodiments, the system 200 may include a client device 400 running a remote interface engine 421 and a device 100 running a modulation engine 59, and data may be exchanged between the engines 59, 421, via electronic communication between a radio 406 of the client device 400 and a radio 53 of the device 100. In some embodiments, a remote interface engine 421 may comprise or function as remote interface logic stored in a memory 310, 410, which may be executable by the processor 302, 402, of a server 300 and/or client device 400. The remote interface engine 421 may receive input from the user 201, preferably through an I/O interface 304, 404, such as a touch screen display, keyboard, mouse, touch pad, etc., and the input may comprise information for selecting or generating a pattern of one or more colors, the light intensity or brightness level(s), and/or length of time(s) for the one or more colors and light intensity or brightness level(s) brightness of illumination that may be generated by the light elements 21 of a device 100. In this manner, a client device 400 may be operable by a user 201 to select the number of illumination settings that the device 100 may use to generate illumination patterns 22.

In preferred embodiments, a remote interface engine 421 may receive data from a modulation engine 59 of a device 100 which may describe one or more arrays, with each array comprising one or more settings and each setting describing a pattern of one or more colors, the light intensity or brightness level(s), and/or length of time(s) for the one or more colors and light intensity or brightness level(s) brightness of illumination that may be generated by the light elements 21 of that device 100. The remote interface engine 421 may display this data to the user 201, such as via a display screen 404A, and the remote interface engine 421 may receive data from the user 201 via an I/O interface 404 describing one or more arrays and/or settings that the user 201 may desire the modulation engine 59 of the device 100 to perform. For example, the remote interface engine 421 may provide a listing of the available arrays and/or settings of a modulation engine 59 of a device 100 is able to perform so that the user 201 can select one or more of the arrays and/or settings and the order in which the modulation engine 59 of a device 100 may perform the selected arrays and/or settings.

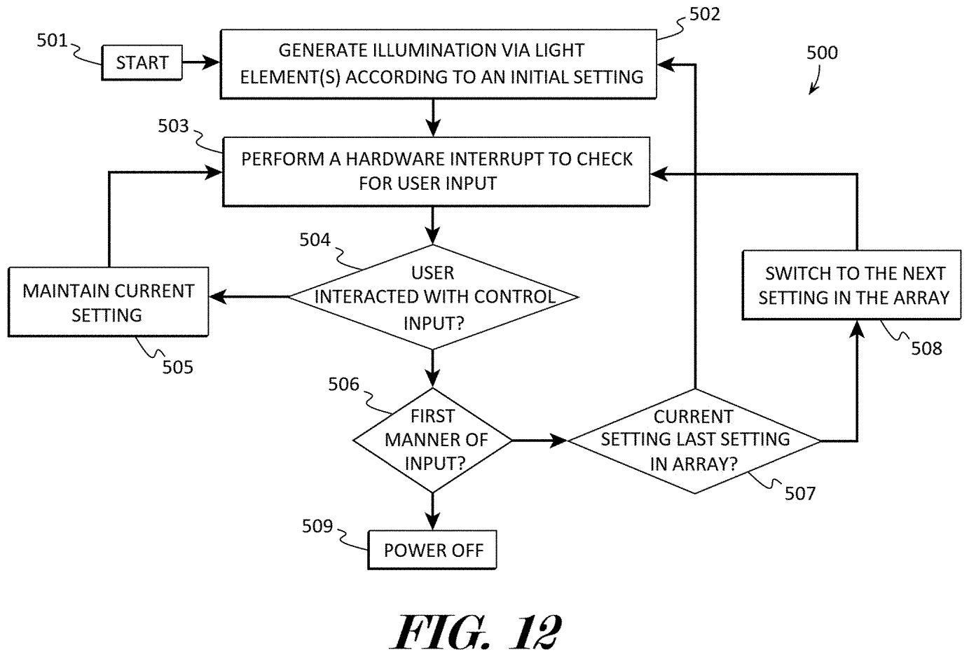

FIG. 12 depicts a computer implemented artwork substrate enhancing method (“the method”) 500 according to various embodiments described herein. In some embodiments, one or more steps of the method 500 may be performed by a device 100 and other elements, such as which may be found in a system 200. In preferred embodiments, a modulation engine 59 of the device 100 may comprise or otherwise have access to one or more arrays with each array comprising one or more settings. Generally, a setting may describe a pattern of one or more colors, the light intensity or brightness level(s), and/or length of time(s) for the one or more colors and light intensity or brightness level(s) brightness of illumination that may be generated by the light elements 21. For example, a setting may comprise alternating the illumination pattern 22 by changing between the colors red, green, and blue, for time periods of 10 seconds for red (decreasing in brightness from high to off), 9 seconds for green (decreasing in brightness from high to off then increasing to high), and 20 seconds for blue (repeatedly pulsing from medium brightness to low brightness).

In some embodiments, the method 500 may start 501 and the light elements 21 may generate an illumination pattern 22 according to an initial setting in step 502. An initial setting may comprise a setting that may be an initial or default setting of an array that is performed upon startup of the device 100. The arrays and settings may be performed by a modulation engine 59 of the device 100. Preferably, a modulation engine 59 may contain a number of arrays and settings which the user 201 may select between by operating one or more control inputs 61 and/or by operating the I/O interfaces of a client device 400 that the device 100 running the modulation engine 59 may be in communication with.

In step 503, the modulation engine 59 may perform a hardware interrupt to check for user input which may be provided by the user 201 interacting with a control input 61.

In decision block 504, the modulation engine 59 may determine if a user 201 has interacted with a control input 61 by detecting if the control input 61 has been modulated. If a user 201 not interacted with a control input 61, the method 500 may proceed to decision block 506. If a user 201 has not interacted with a control input 61, the method 500 may proceed to step 505, and the modulation engine 59 may maintain the current setting resulting in the light elements 21 maintaining the current pattern of color and light intensity of illumination. After step 505, the method 500 may continue to step 503.

In decision block 506, the modulation engine 59 may determine if the user 201 has interacted with the control input 61 in a first manner of input. For example, if the control input 61 is a depressible button, the modulation engine 59 may determine a manner of input that may describe if the control input 61 has simply been pressed and released, pressed a number of times, pressed and held for a period of time (such as one second), etc. In preferred embodiments, a modulation engine 59 may determine in what manner that the user 201 has interacted with the control input 61 so as to detect if a user 201 has provided a first or second input. Continuing the above example, if the control input 61 has simply been pressed and released the modulation engine 59 may determine that a first input has been received, while if the control input 61 has been pressed and held for a period of time (such as one second) the modulation engine 59 may determine that a second input has been received. If the modulation engine 59 determines that a first input has been received, the method 500 may proceed to step 509 and the device 100 may power off If the modulation engine 59 determines that a first input has not been received then the input must be a different input, such as a second input, and the method 500 may proceed to decision block 507.

In decision block 507, the modulation engine 59 may determine if the current setting is the last setting in the array. If the current setting is not the last setting in the array, the method 500 may proceed to step 502. If the current setting is the last setting in the array, the method 500 may proceed to step 508, and the modulation engine 59 may switch to the next setting in the array. The next setting in the array may be any setting, for example a user may press the control input 61 twice and the modulation engine 59 may skip a setting to advance to the next setting in the array. After step 508, the method 500 may continue to step 503.

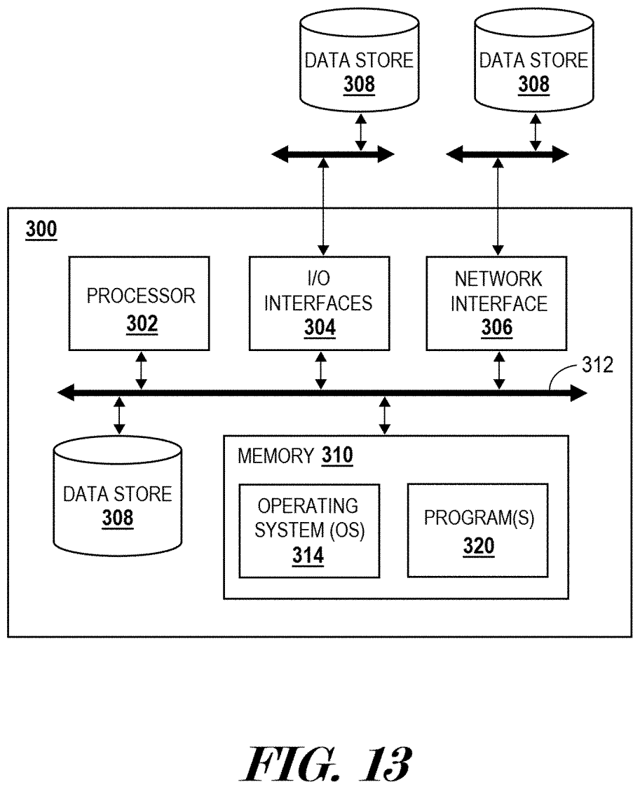

Referring now to FIG. 13, in an exemplary embodiment, a block diagram illustrates a server 300 of which one or more may be used in the system 100 or standalone and which may be a type of computing platform. The server 300 may be a digital computer that, in terms of hardware architecture, generally includes a processor 302, input/output (I/O) interfaces 304, a network interface 306, a data store 308, and memory 310. It should be appreciated by those of ordinary skill in the art that FIG. 13 depicts the server 300 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 may be, for example but not limited to, one or more buses or other wired or wireless connections, as is known in the art. The local interface 312 may have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 may be any custom made or commercially available processor, a central processing unit (CPU), an auxiliary processor among several processors associated with the server 300, a semiconductor-based microprocessor (in the form of a microchip or chip set), or generally any device for executing software instructions. When the server 300 is in operation, the processor 302 is configured to execute software stored within the memory 310, to communicate data to and from the memory 310, and to generally control operations of the server 300 pursuant to the software instructions. The I/O interfaces 304 may be used to receive user input from and/or for providing system output to one or more devices or components. User input may be provided via, for example, a keyboard, touch pad, and/or a mouse. System output may be provided via a display device and a printer (not shown). I/O interfaces 304 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 306 may be used to enable the server 300 to communicate on a network, such as the Internet, the data network 105, the enterprise, and the like, etc. The network interface 306 may include, for example, an Ethernet card or adapter (e.g., 10 BaseT, Fast Ethernet, Gigabit Ethernet, 10 GbE) or a wireless local area network (WLAN) card or adapter (e.g., 802.11a/b/g/n). The network interface 306 may include address, control, and/or data connections to enable appropriate communications on the network. A data store 308 may be used to store data.

The data store 308 is a type of memory and may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media. In one example, the data store 308 may be located internal to the server 300 such as, for example, an internal hard drive connected to the local interface 312 in the server 300. Additionally, in another embodiment, the data store 308 may be located external to the server 300 such as, for example, an external hard drive connected to the I/O interfaces 304 (e.g., SCSI or USB connection). In a further embodiment, the data store 308 may be connected to the server 300 through a network, such as, for example, a network attached file server.

The memory 310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 may include one or more software programs, each of which includes an ordered listing of executable instructions for implementing logical functions. The software in the memory 310 may include a suitable operating system (O/S) 314 and one or more programs 320.

The operating system 314 essentially controls the execution of other computer programs, such as the one or more programs 320, and provides scheduling, input-output control, file and data management, memory management, and communication control and related services. The operating system 314 may be, for example Windows NT, Windows 2000, Windows XP, Windows Vista, Windows 7, Windows 8, Windows 10, Windows Server 2003/2008/2012/2016 (all available from Microsoft, Corp. of Redmond, Wash.), Solaris (available from Sun Microsystems, Inc. of Palo Alto, Calif.), LINUX (or another UNIX variant) (available from Red Hat of Raleigh, N.C. and various other vendors), Android and variants thereof (available from Google, Inc. of Mountain View, Calif.), Apple OS X and variants thereof (available from Apple, Inc. of Cupertino, Calif.), or the like. The one or more programs 320 may be configured to implement the various processes, algorithms, methods, techniques, etc. described herein.

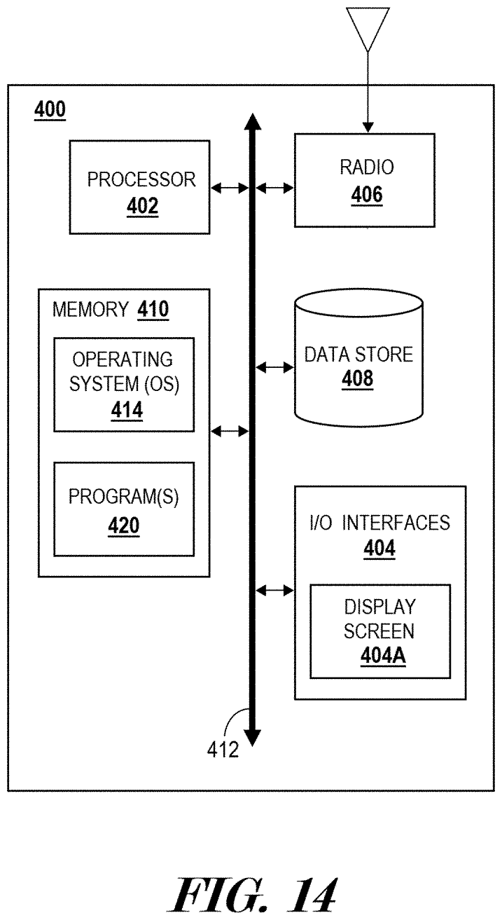

Referring to FIG. 14, in an exemplary embodiment, a block diagram illustrates a client device 400 of which one or more may be used in the system 100 or the like and which may be a type of computing platform. The client device 400 can be a digital device that, in terms of hardware architecture, generally includes a processor 402, input/output (I/O) interfaces 404, a radio 406, a data store 408, and memory 410. It should be appreciated by those of ordinary skill in the art that FIG. 14 depicts the client device 400 in an oversimplified manner, and a practical embodiment may include additional components and suitably configured processing logic to support known or conventional operating features that are not described in detail herein. The components (402, 404, 406, 408, and 410) are communicatively coupled via a local interface 412. The local interface 412 can be, for example but not limited to, one or more buses or other wired or wireless connections, as is known in the art. The local interface 412 can have additional elements, which are omitted for simplicity, such as controllers, buffers (caches), drivers, repeaters, and receivers, among many others, to enable communications. Further, the local interface 412 may include address, control, and/or data connections to enable appropriate communications among the aforementioned components.

The processor 402 is a hardware device for executing software instructions. The processor 402 can be any custom made or commercially available processor, a central processing unit (CPU), an auxiliary processor among several processors associated with the client device 400, a semiconductor-based microprocessor (in the form of a microchip or chip set), or generally any device for executing software instructions. When the client device 400 is in operation, the processor 402 is configured to execute software stored within the memory 410, to communicate data to and from the memory 410, and to generally control operations of the client device 400 pursuant to the software instructions. In an exemplary embodiment, the processor 402 may include a mobile optimized processor such as optimized for power consumption and mobile applications.

The I/O interfaces 404 can be used to receive data and user input and/or for providing system output. User input can be provided via a plurality of I/O interfaces 404, such as a keypad, a touch screen, a camera, a microphone, a scroll ball, a scroll bar, buttons, bar code scanner, voice recognition, eye gesture, and the like. System output can be provided via a display screen 404A such as a liquid crystal display (LCD), touch screen, and the like. The I/O interfaces 404 can also include, for example, a global positioning service (GPS) radio, a serial port, a parallel port, a small computer system interface (SCSI), an infrared (IR) interface, a radio frequency (RF) interface, a universal serial bus (USB) interface, and the like. The I/O interfaces 404 can include a graphical user interface (GUI) that enables a user to interact with the client device 400. Additionally, the I/O interfaces 404 may be used to output notifications to a user and can include a speaker or other sound emitting device configured to emit audio notifications, a vibrational device configured to vibrate, shake, or produce any other series of rapid and repeated movements to produce haptic notifications, and/or a light emitting diode (LED) or other light emitting element which may be configured to illuminate to provide a visual notification.

The radio 406 enables wireless communication to an external access device or network. Any number of suitable wireless data communication protocols, techniques, or methodologies can be supported by the radio 406, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication.

The data store 408 may be used to store data and is therefore a type of memory. The data store 408 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 408 may incorporate electronic, magnetic, optical, and/or other types of storage media.

The memory 410 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 410 may incorporate electronic, magnetic, optical, and/or other types of storage media. Note that the memory 410 may have a distributed architecture, where various components are situated remotely from one another, but can be accessed by the processor 402. The software in memory 410 can include one or more software programs 420, each of which includes an ordered listing of executable instructions for implementing logical functions. In the example of FIG. 14, the software in the memory system 410 includes a suitable operating system (O/S) 414 and programs 420.

The operating system 414 essentially controls the execution of other computer programs, and provides scheduling, input-output control, file and data management, memory management, and communication control and related services. The operating system 414 may be, for example, LINUX (or another UNIX variant), Android (available from Google), Symbian OS, Microsoft Windows CE, Microsoft Windows 7 Mobile, Microsoft Windows 10, iOS (available from Apple, Inc.), webOS (available from Hewlett Packard), Blackberry OS (Available from Research in Motion), and the like.

The programs 420 may include various applications, add-ons, etc. configured to provide end user functionality with the client device 400. For example, exemplary programs 420 may include, but not limited to, a web browser, social networking applications, streaming media applications, games, mapping and location applications, electronic mail applications, financial applications, and the like. In a typical example, the end user typically uses one or more of the programs 420 along with a network 105 to manipulate information of the system 100.

While some exemplary shapes and sizes have been provided for elements of the device 100, it should be understood to one of ordinary skill in the art that the housing 11, light diffusing cover 13, and any other element described herein may be configured in a plurality of sizes and shapes including “T” shaped, “X” shaped, square shaped, rectangular shaped, cylinder shaped, cuboid shaped, hexagonal prism shaped, triangular prism shaped, or any other geometric or non-geometric shape, including combinations of shapes. It is not intended herein to mention all the possible alternatives, equivalent forms or ramifications of the invention. It is understood that the terms and proposed shapes used herein are merely descriptive, rather than limiting, and that various changes, such as to size and shape, may be made without departing from the spirit or scope of the invention.

Additionally, while some materials have been provided, in other embodiments, the elements that comprise the device 100 may be made from or may comprise durable materials such as aluminum, steel, other metals and metal alloys, wood, hard rubbers, hard plastics, fiber reinforced plastics, carbon fiber, fiber glass, resins, polymers or any other suitable materials including combinations of materials. Additionally, one or more elements may be made from or comprise durable and slightly flexible materials such as soft plastics, silicone, soft rubbers, or any other suitable materials including combinations of materials. In some embodiments, one or more of the elements that comprise the device 100 may be coupled or connected together with heat bonding, chemical bonding, adhesives, clasp type fasteners, clip type fasteners, rivet type fasteners, threaded type fasteners, other types of fasteners, or any other suitable joining method.

In other embodiments, one or more of the elements that comprise the device 100 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, a slide-to-lock type connection method or any other suitable temporary connection method as one reasonably skilled in the art could envision to serve the same function. In further embodiments, one or more of the elements that comprise the device 100 may be coupled by being one of connected to and integrally formed with another element of the device 100.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. An artwork substrate enhancing system, the system including:
an artwork substrate enhancing device having a light element and a processing unit, wherein the processing unit is operable to cause at least two different illumination patterns to be generated by the light element, and wherein the artwork substrate enhancing device is configured to direct the at least two different illumination patterns onto an artwork substrate.

2. The system of claim 1, wherein the artwork substrate includes a coloring substrate to which a color vehicle is able to be applied by a user, the color vehicle selected from the group consisting of colored pencil, crayon, marker, pastel, chalk, and paint.

3. The system of claim 1, wherein the light element includes a light emitting diode.

4. The system of claim 1, wherein the artwork substrate enhancing device is configured as a light strip having a plurality of light elements which are arranged in a linear fashion on an elongated housing.

5. The system of claim 1, wherein the artwork substrate enhancing device includes a light diffusing cover.

6. The system of claim 1, wherein the processing unit includes a modulation engine, wherein the modulation engine is operable to allow a user to select a number of illumination settings, and wherein each of the number of illumination settings is used by the modulation engine to generate an illumination pattern.

7. The system of claim 6, wherein the artwork substrate enhancing device includes a control input, and wherein the control input is operable by the user to select the number of illumination settings.

8. The system of claim 6, wherein the artwork substrate enhancing device includes a radio, wherein the system includes a client device in communication with the radio, and wherein the client device is operable by the user to select the number of illumination settings.

9. The system of claim 1, wherein the artwork substrate enhancing device includes a cavity for receiving the artwork substrate.

10. The system of claim 9, wherein access to the cavity is governed by a lid having a viewing portal.

11. The system of claim 1, wherein the artwork substrate enhancing device comprises socket threading.

12. An artwork substrate enhancing system, the system including:
an artwork substrate enhancing device having a light element, a radio, and a processing unit, wherein the processing unit includes a modulation engine that is operable to allow a user to select a number of illumination settings, each illumination setting including at least two different illumination patterns to be generated by the light element, wherein the at least two different illumination patterns generated by the light element are directed onto an artwork substrate; and
a client device in communication with the radio, wherein the client device is operable by the user to provide input to the program to select the illumination settings.

13. The system of claim 12, wherein the artwork substrate enhancing device includes a control input, and wherein the control input is operable by the user to select the number of illumination settings.

14. The system of claim 12, wherein the artwork substrate includes a coloring substrate to which a color vehicle is able to be applied by a user, the color vehicle selected from the group consisting of colored pencil, crayon, marker, pastel, chalk, and paint.

15. The system of claim 12, wherein the light element includes a light emitting diode.

16. The system of claim 12, wherein the artwork substrate enhancing device is configured as a light strip having a plurality of light elements which are arranged in a linear fashion on an elongated housing.

17. The system of claim 12, wherein the artwork substrate enhancing device includes a light diffusing cover.

18. The system of claim 12, wherein the artwork substrate enhancing device includes a cavity for receiving the artwork substrate.

19. The system of claim 18, wherein access to the cavity is governed by a lid having a viewing portal.

20. The system of claim 12, wherein the artwork substrate enhancing device comprises socket threading.
